(19) United States
(12) Patent Application Publication
(10) Pub. No.: US 2013/0016451 A1
(43) Pub. Date: Jan. 17, 2013

(54) DOUBLE-LAYER CAPACITOR

(71) Applicants: Stefan Kaskel, Dresden (DE); Marcus Rose, Aachen (DE); Lars Borchardt, Dresden (DE)

(72) Inventors: Stefan Kaskel, Dresden (DE); Marcus Rose, Aachen (DE); Lars Borchardt, Dresden (DE)

(21) Appl. No.: 13/578,874

(22) PCT Filed: Feb. 10, 2011
(86) PCT No.: PCT/DE11/00153

§ 371 Date: Oct. 4, 2012

(30) Foreign Application Priority Data
Feb. 17, 2010 (DE) 10 2010 009 308.4
Jun. 1, 2010 (DE) 10 2010 022 831.1

(51) Int. Cl. H01G 9/00

(52) U.S. Cl. 361/502

(57) ABSTRACT

The invention relates to double layer capacitors with which a storage of electric energy with high energy density and specific electric capacitance is possible. In the double layer capacitor, two electrodes are arranged at a spacing from one another. They are formed from porous carbon and provided with electric connector contacts. The double layer capacitor is arranged in an electrolyte or the electrodes are wetted with an electrolyte. In this respect, the carbon forming the electrode(s) was obtained from a carbide by chemical reaction for at least one electrode. A specific surface of at least 2000 m²/g and, in addition to pores having a first pore size fraction having pore sizes up to a maximum of 2 nm, additionally a second pore size fraction having a pore size larger than 2 nm up to a maximum of 20 nm should be achieved in the carbon.

The invention relates to double layer capacitors, which are also called “supercaps” and with which a storage of electric energy with high energy density and specific electric capacitance is possible. In this respect two electrodes are wetted by an electrolyte or they are arranged in an electrolyte. The two electrodes are electrically separated from one another. An electrically insulating membrane is usually arranged between the two electrodes for this purpose. In a charging procedure of the capacitor, an electric potential difference between the two electrodes is utilized and electrolyte ions are in this respect accumulated in the form of an electrochemical double layer at the electrode surface. Ions with an electrically positive charge are accumulated at the electrode with a negative electric potential and ions with a negative electric potential are accumulated at the positive electrode. On a discharge, the ions diffuse back from the surface again and a charge equalization occurs in the electrolyte.

It is known in this respect that an electrode material should advantageously be used which has a very large specific surface and as many small pores as possible. These demands can be satisfied by carbon in the most varied modification. Such porous carbon can be produced from precursors containing carbon.

It is thus proposed in WO 2003/123784 A2 to form the electrodes from carbon which has been obtained by chemical reaction of TiC. In this respect, however, only pores having a pore size in the range 0.1 nm to 3 nm should be present for a good storage of electrolyte ions. A maximum deviation from a mean pore size of 0.05 nm should be permitted.

Accordingly, only pores having an extremely small pore size in the low nanometer range are present in the carbon material. No larger pores may therefore be present in the mesopore size range in accordance with the technical teaching which can be seen from this prior art. The pore size is exclusively designed for the storage capability for electrolyte ions. A differentiated pore size formation is also not possible using the manufacturing process described therein. Since only a uniform pore formation can be achieved by the chemical treatment of powdery TiC with chlorine gas at an elevated temperature since the titanium is uniformly converted into TiCl₄ in the volume.

It has been found that the electric properties of a capacitor can be improved using such an electrode material in comparison with carbon modified in a different form as the electrode material.

A particular advantage of these double layer capacitors is the very high achievable number of charge/discharge cycles as well as the high specific electric capacitance. The double layer capacitors known from WO 2003/123784 A2 can, however, only use this advantage with limitations since their response behavior has deficits on charging and discharging, which in particular has a disadvantageous effect with high electric current densities. On an operation with high power, only a limited portion of the capacitance can, however, thus be used. Longer times for a charge and discharge of such a capacitor are required for a utilization of the total capacitance.

It is therefore the object of the invention to provide double layer capacitors which have a high specific capacitance, energy and power density as well as an improved response behavior on charging and discharging and in addition the electrodes of the double layer capacitors can be manufactured reproducibly with a defined porosity.

This object is achieved in accordance with the invention by double layer capacitors having the features of claim 1. Advantageous embodiments and further developments of the invention can be achieved using features designated in the subordinate claims.

In a double layer capacitor in accordance with the invention, two electrodes are present which are arranged at a spacing from one another. A membrane can be arranged between the electrodes for this purpose which separates them from one another electrically and which is permeable for the electrolyte, at least for the electrolyte ions. The electrodes are formed from porous carbon. The carbon with which at least one of the electrodes is formed has been obtained from a carbide by chemical reaction. The electrodes are provided with electric connector contacts and the double layer capacitor is arranged in an electrolyte or is wetted thereby. The carbon forming the at least one electrode has a specific surface of at least 2000 m²/g. In addition to pores having a first pore size fraction up to a maximum of 2 nm, a second pore size fraction having a pore size larger than 2 nm up to a maximum of 10 nm is additionally present in the carbon. Such a carbon is also called a CDC (carbide derived carbon). The pore size of the first pore size fraction should lie between 1 nm and 2 nm.

It is advantageous in this respect that pores of the first pore size refraction of a maximum of 2 nm having a portion of 0.3 cm³/g to 1.5 cm³/g, preferably up to 0.7 cm³/g and pores of the second pore size refraction in the range from 2 nm up to 10 nm having a portion of 0.2 cm³/g to 1.8 cm³/g, preferably 0.8 cm³/g to 1.8 cm³/g, are present in the carbon. It can thereby be ensured that, in addition to a high achievable energy density and capacitance, a good and faster ion transport is also possible on the diffusion of the electrolyte ions into the pores and also out of them again for the charging and discharging.

The pores of the second pore size fraction (mesopores) can be present in a periodic/directed order, preferably arranged in a cubic and/or hexagonal grid, by the manner of the manufacture of the carbide derived carbon. A direction connection of the inner surface to the outer surface can thereby be utilized for the diffusion of ions.

It is favorable in this respect if pores of the first and of the second pore size fraction are arranged distributed homogeneously in the carbon forming the electrodes.

In this respect, the pore size of the pores which can be associated with the second pore size fraction and which are also called mesopores lies above the size of the electrolyte ions used. It can be at least twice the size of the ion size.

The electrodes which can be used in the invention can preferably be formed with SiC having carbon and pores having a pore size in the range of 2 nm to 10 nm. How this can be achieved will be described in the following.

The metallic electric connector contacts can be connected with material continuity and electrically conductively to the electrodes by an electrically conductive layer on the side of the electrodes disposed opposite the membrane. The electric transfer resistance between the electrode and the connector contact can thereby be reduced. The electric conductivity can be achieved with a high portion of graphite in a polymer or with another suitable binding agent.

The two electrodes of a double layer capacitor should each have a layer thickness in the range 30 gm to 300 μm.

The carbon forming the electrodes can be bound to a polymer, with the portion of polymer being kept to less than 20 mass %, preferably less than 10 mass %, particularly preferably up to a maximum of 5 mass %.

Specific electric capacitances of up to 180 F/g can be achieved with double layer capacitors in accordance with the invention. A specific surface of the electrode material into the range from 2500 m²/g up to 3000 m²/g can be achieved.

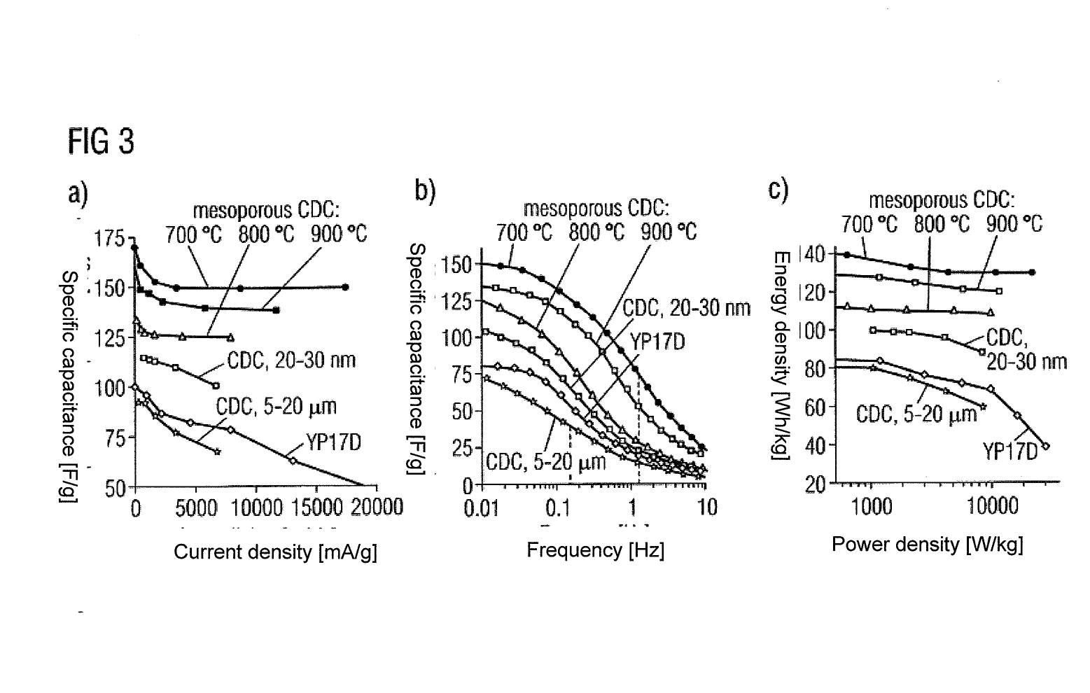

The invention has a particularly good effect with high electric charge and discharge currents. A double layer capacitor in accordance with the invention can thus still have 89% of its total capacitance at 17 A/g, whereas a comparable capacitor with electrodes formed from conventional carbon can only reach 51% of the total capacitance with the same design under comparable conditions. This circumstance can be seen from the diagram shown in FIG. 3a.

The invention will be explained in more detail by way of example in the following.

There are shown:

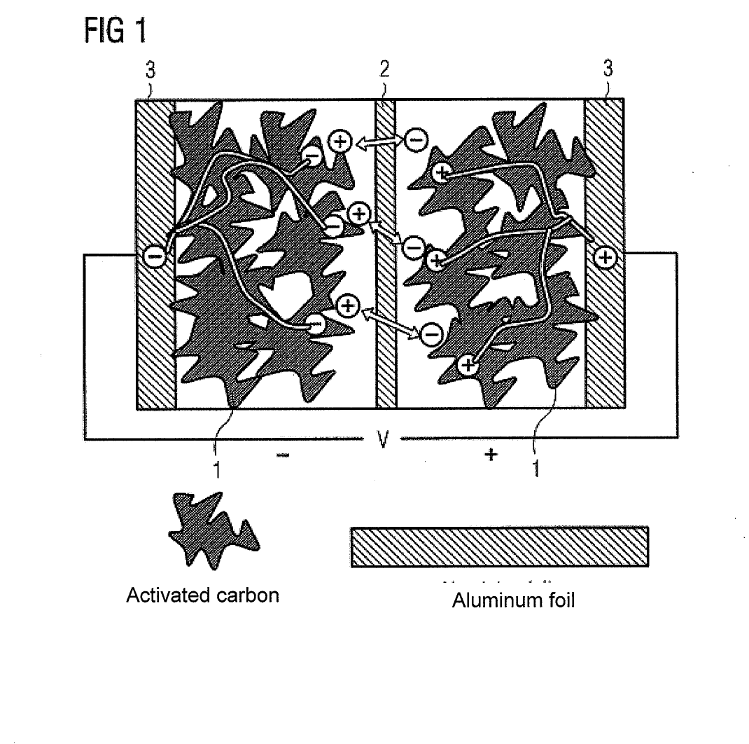

FIG. 1 a design of a double layer capacitor in schematic form;

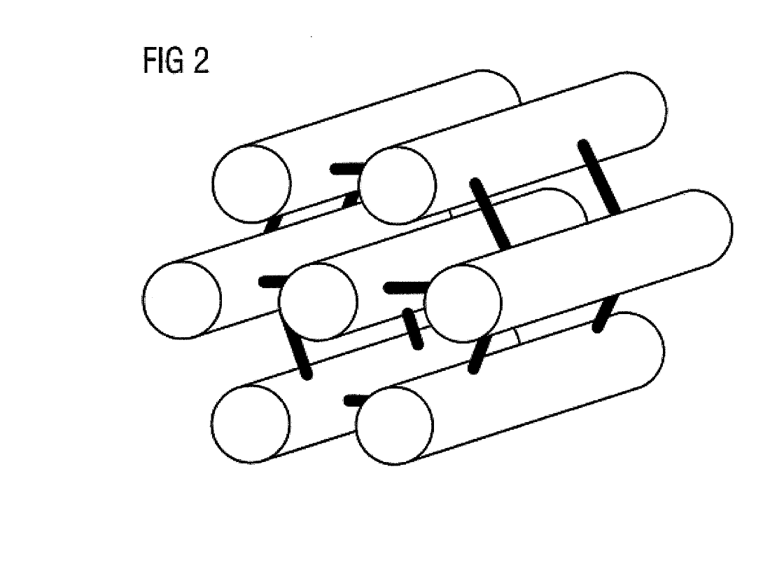

FIG. 2 the design of a precursor of SiC comprising mesopores in schematic form; and

FIGS. 3a to 3c diagrams for electrodes which have been obtained from SiC at different temperatures.

The basic design of a double layer capacitor is shown in FIG. 1, not to scale. An ion permeable membrane 2 is arranged between two carbon electrodes 1 and separates the two electrodes 1 from one another but is in areal touching contact with them. Electric connector contacts 3 are fastened at the oppositely disposed surfaces to the electrodes 1 via which the electrically conductive connection to an electric voltage source or, in a form not shown, to a consumer can be made. A double layer capacitor can be provided in all conceivable capacitor forms (e.g. as a stacked or wound arrangement). The ions of an electrolyte present around the double layer capacitor can diffuse into the pore structure of the electrodes 1 on the charging of the capacitor and can be held within the pores until a discharge procedure. In this respect, the charging is accelerated by the faster diffusion with the pores of the second pore size fraction. The pores of the first pore size fraction are better suited for the storage of the ions.

On discharging, the ion transport reverses and the ions enclosed in the pores of the electrodes 1 up to then exit the electrode material and move back into the electrolyte.

Possibilities for the manufacture of an example of a double layer capacitor in accordance with the invention will be explained with reference to an embodiment.

A first precursor of SiO₂ in which mesopores, that is pores having a pore size in the range 2 nm to 50 nm can be used for the manufacture of a carbon which can be used for electrodes in the invention. 2 g of this SiO₂ are then infiltrated into heptane-butanol with 2.5 g of a polycarbosilane solution and the liquid is evaporated over approx. 12 h while stirring.

The obtained powder is then heated up to a temperature of 1000° C. in an aluminum oxide boat in a furnace under argon with a volume flow of approx. 40 ml/min. In this respect, heating first takes place to 300° C. at a heating rate of 2.5 K/min, starting from room temperature, and the 300° C. is then maintained over a period of 5 h. Subsequently thereto, heating takes place to 700° C. at a heating rate of 0.5 K/min and after reaching the 700° C. the heating rate is increased to 2 K/min and the temperature up to 1000° C. This temperature is maintained for 2 h and then cooled to room temperature.

In this respect, a precursor can additionally be used in which additional carbon is introduced by infiltration with divinylbenzene using polycarbosilane. This can take place over a period of approx. 12 h under vacuum. In the following example, this has thus been carried out for a sample which has been treated by chlorine at 800° C.

After the first heating treatment, which was described above, a heating was again carried out to 300° C. at a heating rate of 2.5 K/min in an argon atmosphere. This temperature was maintained for 5 h. Subsequently thereto, the temperature was increased to 700° C. The heating took place at a heating rate of 0.5 K/min. After reaching the 700° C., the temperature was increased to 1000° C. with a heating rate increased to 2 K/min and the 1000° C. was maintained for a period of 2 h and then cooled to room temperature. Subsequently, the silicon oxide matrix was removed by an acid treatment step in a solution of 40 ml water, 40 ml hydrofluoric acid (40%) and was then washed with an excess of ethanol and subsequently dried.

A precursor of SiC was thus able to be obtained in which mesopores having a pore size in the range 2 nm to 8 nm, that is the second pore size fraction, were present and arranged hexagonally. FIG. 2 shows this in schematic form. As will be explained in the following, pores of the first pore size fraction can then additionally be formed in the bar-shaped regions by the removal of silicon.

The SiC precursor was subjected to a further heat treatment to remove the silicon. In this respect, a heating was carried out in three samples to a maximum temperature of 700° C. (mesoporous CDC 700° C.), of 800° C. (mesoporous CDC 800° C.) and of 900° C. (mesoporous CDC 900° C.) at a heating rate of 7.5 K/min in a chlorine atmosphere. The respective maximum temperature was maintained for 2 h. In this respect, the carbon for the electrode material was formed in accordance with

sic+2 Cl₂→SiCl₄+C

Subsequently ammonia was employed at 600° C. for 3 h to remove any residual chlorine.

The obtained carbon powder was mixed with an ethanol polytetrafluoroethylene (PTFE) mixture as a solution in 60 mass % water. The obtained mixture contained 95 mass % carbon and 5 mass % PTFE. The ethanol was removed by evaporation. The solvent-free carbon PTFE mixture with a pasty consistence was dried at 80° C. over a time period of at least 8 h in vacuum and was able to be used as a thin film having a film thickness of 150 μm for electrodes of a double layer capacitor with a symmetric design. The carbon particles bound with the PTFE have pores with both pore size fractions. A direct connection of the outer surface of the particle to the inner surface of the particle was able to be achieved in every particle with the pores of the second pore size fraction for an ion movement into the pores of the first pore size fraction and out of them again.

A 300 μm thick aluminum foil was used for the electric connector contacts and was roughened at the surface to which it should be connected to an electrode. An application took place on this surface of an electrically conductive layer with which the aluminum film forming the connector contact is connected over the full area with material continuity and electrically conductively to the one surface of an electrode.

A 25 μm thick membrane having a porosity of 60% and permeable for electrolyte ions was arranged as a membrane between the two electrodes of a double layer capacitor. In this respect, the electrodes contacted the membrane areally at the two oppositely disposed sides. This structure was clamped between two plates of PTFE and was added into a vessel filled with argon. Less than 1 ppm water was contained in the vessel atmosphere. A heating to 120° C. was carried out for the degasing. This took place over a period of 2 h. After cooling to room temperature, the double layer capacitor was placed into a vessel of glass in which 1 M tetraethylammonium tetrafluoroboreate salt (TEABF₄) was contained in an acetonitrile solution 99.9% extra dry, such as can be obtained from Acros Organics, Geel, Belgium, as an example of a suitable organic electrolyte. The TEABF₄ salt was dried at 150° C. in the closed vessel in a vacuum furnace for 2 h before the manufacture.

The glass vessel containing the double layer capacitor with electrolyte was received in a gas-tight glass vessel through which electrical feed lines were conducted from the outside for the electrochemical examinations.

In this respect, electrochemical examinations were carried out in charging and discharging procedures. The electrochemical impedance spectroscopy was determined at frequencies in the range 10 mHz to 100 kHz with a 10 mV AC amplitude.

The gravimetric capacitance C (F/g) was determined in accordance with

C=2/2πfIm(Z)m

In this respect, f is the operating frequency in Hz, Im(Z( ) is the imaginary part of the total resistance in ohms and m is the mass of the carbon of the respective electrode in g.

The charging and discharging took place with electric voltages between 0 V and 2 V. The electric currents were in the range 100 mA/g to 1500 mA/g with respect to the mass of the electrodes.

The gravimetric capacitance C (F/g) can be determined by

C=2I/(dV/dt)m

Here I is the electric current (A), dV/dt is the increase in the discharge curve (V/s) and m is the mass of carbon in g of each electrode.

The energy density E (Wh/kg) for the electrodes, can be determined by

E=(CV²/2)*1000 (g/kg)*(1/3600)(Wh/J)

C is here the gravimetric capacitance of the electrode (F/g) calculated at different current densities; V is the electric operating voltage of a double layer capacitor. The power density P(W/kg) can be calculated by dividing the energy densities of the electrodes by the discharge time (in h) at different current densities.

This can be seen from the diagrams of FIGS. 3a to 3c for different electrode materials which were manufactured at different temperatures (700° C., 800° C. and 900° C.) and with a chlorine gas supply. The following Table 1 in this respect reproduces the examined electrode materials. CDC, 5-20 Am, CDC 2-30 nm and YP17D are conventional comparison examples.

TABLE 1

| Name | Description |
|---|---|
| Mesoporous CDC, | in accordance with the invention, |
| 700° C. | chlorination temperature 700° C. |
| Mesoporous CDC, | in accordance with the invention, |
| 800° C. | chlorination temperature 800° C. |
| Mesoporous CDC, | in accordance with the invention, |
| 900° C. | chlorination temperature 900° C. |
| CDC, 5-20 μm | CDC from conventional SiC microparticles |
| CDC, 20-30 nm | CDC from SiC nanoparticles, conventional |
| YP17D | Commercial activated carbon (Kuraray |
| | Chemical, Osaka, Japan) |

Table 2 gives values for the specific surface achieved in each case for electrode materials in accordance with the invention and for comparison examples and the portion of the pores having a diameter larger than 2 nm at the specific surface.

TABLE 2

| | Specific | Surface of pores > |
|---|---|---|
| Name | surface (m²/g) | 2 nm (m²/g) |
| Mesoporous CDC, | 2250 | 490 |
| 700° C. | | |
| Mesoporous CDC, | 2430 | 490 |
| 800° C. | | |
| Mesoporous CDC, | 2420 | 480 |
| 900° C. | | |
| CDC, 5-20 μm | 1100-1200 | 13-40 |
| CDC, 20-30 nm | 1300-1310 | 220-260 |

1. A double layer capacitor, wherein two electrodes (1) are arranged at a spacing from one another, wherein the electrodes (1) are formed from porous carbon and are provided with electric connector contacts (3) and the double layer capacitor is arranged in an electrolyte or the electrodes (1) are wetted by an electrolyte;
wherein in this respect the carbon forming the electrode(s) (1) is obtained from a carbide by chemical reaction for at least one electrode (1) and has a specific surface of at least 2000 m²/g and, in addition to pores having a first pore size fraction having pore sizes up to a maximum of 2 nm, additionally a second pore size fraction is present having a pore size greater than 2 mm up to a maximum of 20 nm in the carbon.

2. A double layer capacitor in accordance with claim 1, characterized in that pores of the first pore size fraction of a maximum of 2 nm with a portion of 0.3 cm³/g to 1.5 cm³/g and pores of the second pore size fraction in the range from 2 nm to 10 nm with a portion of 0.2 cm³/g to 1.8 cm³/g are present in the carbon.

3. A double layer capacitor in accordance with claim 1, characterized in that pores of the second pore size fraction are present in a periodic order in the carbon.

4. A double layer capacitor in accordance with claim 3, characterized in that pores of the second pore size fraction are arranged in a cubic and/or hexagonal grid in the carbon.

5. A double layer capacitor in accordance with claim 1, characterized in that pores of the first and of the second pore size fraction are arranged distributed homogeneously in the carbon forming the electrodes (1).

6. A double layer capacitor in accordance with claim 1, characterized in that the electrodes (1) are formed by SIC having carbon and pores having a pore size in the range 2 nm to 10 nm.

7. A double layer capacitor in accordance with claim 1, characterized in that metallic electric connector contacts (3) are connected to the electrodes (1) with material continuity and electrically conductively by an electrically conductive polymer on the side of the electrodes (1) disposed opposite the membrane (2).

8. A double layer capacitor in accordance with claim 1, characterized in that the electrodes (1) have a layer thickness in the range 30 μm to 300 μm.

9. A double layer capacitor in accordance with claim 1, characterized in that the carbon forming the electrodes (1) is bound to a polymer, with the portion of polymer being less than 20 mass %.

10. A double layer capacitor in accordance with claim 1, characterized in that an electrically insulating membrane (2) permeable for the electrolyte is arranged between the electrodes (1).
